(19) United States
(12) Patent Application Publication
(10) Pub. No.: US 2014/0165837 A1
(43) Pub. Date: Jun. 19, 2014

(54) METHOD FOR MANUFACTURING CARBON DIOXIDE SEPARATION MEMBRANE, AND CARBON DIOXIDE SEPARATION MEMBRANE

(71) Applicants: Naomichi Kimura, Osaka (JP); Hideyuki Emori, Osaka (JP); Hiroyuki Nishii, Osaka (JP); Takuji Shintani, Osaka (JP)

(72) Inventors: Naomichi Kimura, Osaka (JP); Hideyuki Emori, Osaka (JP); Hiroyuki Nishii, Osaka (JP); Takuji Shintani, Osaka (JP)

(73) Assignee: NITTO DENKO CORPORATION, Ibaraki-shi, Osaka (JP)

(21) Appl. No.: 14/238,771

(22) PCT Filed: Aug. 13, 2012
(86) PCT No.: PCT/JP2012/005143

§ 371 Date: Feb. 13, 2014

(30) Foreign Application Priority Data
Aug. 17, 2011 (JP) 2011-178380

(51) Int. Cl. B01D 71/34; B01D 67/00

(52) U.S. Cl. CPC B01D 71/34; B01D 67/009
USPC 96/12; 96/11; 264/495

(57) ABSTRACT

The present invention provides a carbon dioxide separation membrane having a grafted chain into which a substituent having high selective affinity for carbon dioxide is introduced and thus having high carbon dioxide separation capability. The present invention is a method for producing a carbon dioxide separation membrane. This method includes the steps of: (1) irradiating a polymer film with radiation; (2) forming, in the irradiated polymer film, a grafted chain containing a repeating unit of a monomer having a substituent capable of forming a salt with a fluoride ion; and (3) subjecting the substituent capable of forming a salt with a fluoride ion to treatment with a fluoride salt so as to form a salt with a fluoride ion in the substituent.

### TECHNICAL FIELD

The present invention relates to a method for producing a carbon dioxide separation membrane using radiation-induced graft polymerization, and to a carbon dioxide separation membrane.

### BACKGROUND ART

It is conventionally known that a polymeric material has its own gas permeability and a specific gas component can be separated through a membrane made of the polymeric material. The use of membranes for separating gas components is applied to various fields because this technique has advantages such as less energy consumption, smaller equipment, and easier maintenance of the equipment.

Recently, greenhouse gas emissions causing the global warming, in particular, carbon dioxide emissions have been identified as problems, and there is a strong demand for development of membranes capable of separating gas components, in particular, gas separation membranes capable of separating carbon dioxide from other gases with high selectivity. This technique can be applied to various applications such as separation of carbon dioxide from combustion exhaust gases, separation of carbon dioxide from natural gases, separation, capture, and storage of carbon dioxide in integrated coal gasification combined cycle power generation, and separation of carbon dioxide in membrane reactors for hydrogen production for fuel cells.

In carbon dioxide separation membranes for these applications, polymer compounds containing substituents having high selective affinity for carbon dioxide are used.

On the other hand, there is a technique of introducing a monomer having a functional group into a polymer by graft polymerization so as to immobilize the functional group in the polymer and crosslink it to the polymer, and this technique is considered to increase the durability.

Patent Literature 1 is an example of the introduction of a monomer having a functional group into a polymer by graft polymerization. Patent Literature 1 discloses a method for producing a solution diffusion membrane. In this method, a polymer film is irradiated with an electron beam, a monomer having a group capable of forming a salt or a group easily convertible into a group capable of forming a salt is graft-copolymerized onto the polymer film, and that group in the graft polymer thus obtained is converted into an ionized salt. Patent Literature 1 describes that this solution diffusion membrane can be used as a gas separation membrane.

However, Patent Literature 1 is intended to be used mainly as a pervaporation membrane, and neither describes the type of a gas to be separated through the membrane when it is used as a gas separation membrane, nor provides examples of carbon dioxide separation. As a result of studies, the present inventors have found that the membrane described in Patent Literature 1 has room for improvement in its carbon dioxide separation capability.

### CITATION LIST

### Patent Literature

Patent Literature 1: JP 04(1992)-78328 B2

### SUMMARY OF INVENTION

### Technical Problem

It is an object of the present invention to provide a carbon dioxide separation membrane having a grafted chain into which a substituent having high selective affinity for carbon dioxide is introduced and thus having high carbon dioxide separation capability.

### Solution to Problem

The present invention that has solved the above-described problems is a method for producing a carbon dioxide separation membrane. This method includes the steps of: (1) irradiating a polymer film with radiation; (2) forming, in the irradiated polymer film, a grafted chain containing a repeating unit of a monomer having a substituent capable of forming a salt with a fluoride ion; and (3) subjecting the substituent capable of forming a salt with a fluoride ion to treatment with a fluoride salt so as to form a salt with a fluoride ion in the substituent.

It is preferable that in the step (2), the substituent capable of forming a salt with a fluoride ion be a quaternary ammonium group, and that the step (2) include the steps of graft-polymerizing a monomer having a substituent convertible into a quaternary ammonium group onto the irradiated polymer film; and converting the substituent convertible into a quaternary ammonium group into a quaternary ammonium group.

Preferably, the substituent convertible into a quaternary ammonium group is at least one selected from the group consisting of a pyridyl group, an imidazolyl group, a primary amino group, a secondary amino group, a tertiary amino group, and a halogenated alkyl group.

In the step of graft-polymerizing the monomer having the substituent convertible into a quaternary ammonium group in the step (2), a graft ratio is preferably 15 to 130% by weight.

Preferably, the polymer film is a film of at least one polymer selected from the group consisting of polystyrene, polyetheretherketone, polyetherketone, polysulfone, polyethersulfone, polyphenylene sulfide, polyarylate, polyetherimide, aromatic polyimide, polyamideimide, polyethylene, polypropylene, polyvinylidene fluoride, polyvinyl fluoride, ethylene-tetrafluoroethylene copolymer, vinylidene fluoride-hexafluoropropylene copolymer, crosslinked polytetrafluoroethylene, tetrafluoroethylene-perfluoroalkyl vinyl ether copolymer, and tetrafluoroethylene-hexafluoropropylene-vinylidene fluoride copolymer.

In another aspect, the present invention is also a carbon dioxide separation membrane including a polymer film having a grafted side chain containing a repeating unit of a monomer having a substituent forming a salt with a fluoride ion.

Preferably, the substituent forming a salt with a fluoride ion is a quaternary ammonium group forming a salt with a fluoride ion.

Preferably, the polymer film is a film of at least one polymer selected from the group consisting of polystyrene, polyetheretherketone, polyetherketone, polysulfone, polyethersulfone, polyphenylene sulfide, polyarylate, polyetherimide, aromatic polyimide, polyamideimide, polyethylene, polypropylene, polyvinylidene fluoride, polyvinyl fluoride, ethylene-tetrafluoroethylene copolymer, vinylidene fluoride-hexafluoropropylene copolymer, crosslinked polytetrafluoroethylene, tetrafluoroethylene-perfluoroalkyl vinyl ether copolymer, and tetrafluoroethylene-hexafluoropropylene-vinylidene fluoride copolymer.

Preferably, a graft ratio of the grafted side chain is 20 to 200% by weight.

### Advantageous Effects of Invention

The present invention provides a carbon dioxide separation membrane having a grafted chain into which a substituent having high selective affinity for carbon dioxide is introduced and thus having high carbon dioxide separation capability.

### DESCRIPTION OF EMBODIMENTS

The method for producing a carbon dioxide separation membrane of the present invention includes the steps of: (1) irradiating a polymer film with radiation; (2) forming, in the irradiated polymer film, a grafted chain containing a repeating unit of a monomer having a substituent capable of forming a salt with a fluoride ion; and (3) subjecting the substituent capable of forming a salt with a fluoride ion to treatment with a fluoride salt so as to form a salt with a fluoride ion in the substituent.

Step (1)

A polymer film used in the present invention is not particularly limited as long as it can be subjected to radiation-induced graft polymerization, and is preferably a film of one polymer selected from the group consisting of aromatic polymers, olefin polymers, and fluorinated olefin polymers, in terms of electrochemical stability, mechanical strength and the like.

Examples of the aromatic polymers include polystyrene, polyethylene terephthalate, polybutylene terephthalate, polytrimethylene terephthalate, polyethylene naphthalate, polybutylene naphthalate, polyetheretherketone, polyetherketone, polysulfone, polyethersulfone, polyphenylene sulfide, polyarylate, polyetherimide, aromatic polyimide, and polyamideimide.

Examples of the olefin polymers include polyethylene (for example, high-density polyethylene, low-density polyethylene, and ultra-high-molecular-weight polyethylene), polypropylene, polybutene, and polymethylpentene.

Examples of the fluorinated olefin polymers include polyvinylidene fluoride, polyvinyl fluoride, ethylene-tetrafluoroethylene copolymer, vinylidene fluoride-hexafluoropropylene copolymer, tetrafluoroethylene-hexafluoropropylene copolymer, polytetrafluoroethylene, crosslinked polytetrafluoroethylene, tetrafluoroethylene-perfluoroalkyl vinyl ether copolymer, polychlorotrifluoroethylene, and tetrafluoroethylene-hexafluoropropylene-vinylidene fluoride copolymer.

More preferably, the polymer film is a film of at least one polymer selected from the group consisting of polystyrene, polyetheretherketone, polyetherketone, polysulfone, polyethersulfone, polyphenylene sulfide, polyarylate, polyetherimide, aromatic polyimide, polyamideimide, polyethylene, polypropylene, polyvinylidene fluoride, polyvinyl fluoride, ethylene-tetrafluoroethylene copolymer, vinylidene fluoride-hexafluoropropylene copolymer, crosslinked polytetrafluoroethylene, tetrafluoroethylene-perfluoroalkyl vinyl ether copolymer, and tetrafluoroethylene-hexafluoropropylene-vinylidene fluoride copolymer. Furthermore, since fluorinated olefin polymers are preferable in terms of chemical stability, it is particularly preferable that the polymer film be a film of at least one polymer selected from the group consisting of polyvinylidene fluoride, polyvinyl fluoride, ethylene-tetrafluoroethylene copolymer, vinylidene fluoride-hexafluoropropylene copolymer, and tetrafluoroethylene-hexafluoropropylene-vinylidene fluoride copolymer.

It is preferable to control the crystallinity of the polymer film. The preferred crystallinity varies with the type of the polymer used. For example, in the case of a fluorinated olefin polymer, the crystallinity is preferably 30% or more, and more preferably 40% or more. If the crystallinity is too low, the separation performance tends to decrease. Likewise, the crystallinity is preferably 70% or less, and more preferably 60% or less. If the crystallinity is too high, it is difficult to form a grafted chain, and the permeation flow rate tends to decrease.

The most important property of carbon dioxide separation membranes is the carbon dioxide permeability, and it is preferable to reduce the thickness of the membrane in order to increase the carbon dioxide permeability. However, a too small thickness of the membrane can cause problems such as a decrease in the strength of the membrane, which makes the membrane susceptible to damage and defects such as pinholes. Therefore, the final thickness of the carbon dioxide separation membrane is preferably 6 to 130 μm, and more preferably 12 to 70 μm. Since a grafted chain is introduced into the polymer film in the production of the carbon dioxide separation membrane, the thickness of the resulting carbon dioxide separation membrane is increased in accordance with the graft ratio and thus is slightly greater than the thickness of the polymer film. Therefore, the thickness of the polymer film is preferably 5 to 100 μm, and more preferably 10 to 50 μm.

Ionizing radiation such as a rays, β rays, γ rays, electron rays, and ultraviolet rays can be used as the radiation to which the polymer film is exposed. γ rays and electron rays are preferred, and electron rays are particularly preferred. It is difficult to obtain the geometric effect of y-ray irradiation due to strong diffraction of γ rays, and it is difficult to handle a rays or the like in terms of safety. In contrast, since electron rays are highly safe and highly linear, it is possible to obtain a film that accurately reflects the irradiation geometry by radiation-induced graft polymerization. The radiation dose required for the graft polymerization is preferably 1 to 500 kGy, and more preferably 10 to 300 kGy. If the radiation dose is less than 1 kGy, radical production may decrease, which makes it difficult to cause graft polymerization. If the radiation dose is more than 500 kGy, the crosslinking reaction may proceed excessively or the polymer may degrade.

There are the following methods for radical polymerization of a polymer by irradiation with radiation: a peroxide method in which a polymer is irradiated with radiation to undergo a radical reaction in the presence of oxygen; and a polymer radical method in which a polymer is irradiated with radiation to undergo a radical reaction in the absence of oxygen. In the peroxide method, a graft reaction proceeds from an oxygen radical bonded to the polymer. On the other hand, in the polymer radical method, a graft reaction proceeds from a radical generated in the polymer. Here, it is preferable to allow the radical polymerization to proceed by the polymer radical method in order to prevent the graft reaction from being inhibited by the presence of oxygen. Therefore, it is preferable to irradiate the polymer film with radiation in an inert gas atmosphere or in a vacuum. The temperature of the irradiation (irradiation temperature) is preferably −100° C. to 100° C., and more preferably −100° C. to 60° C. If the irradiation temperature is too high, the generated radicals are easily deactivated.

In order to prevent the deactivation of the radicals, it is desirable to keep the irradiated polymer film at a low temperature equal to or lower than the glass transition temperature of the polymer constituting the film.

Step (2)

The procedure of the step (2) is not particularly limited as long as a grafted chain containing a repeating unit of a monomer having a substituent capable of forming a salt with a fluoride ion is formed in the irradiated polymer film. Preferably, the step (2) is carried out by performing: a step of graft-polymerizing a monomer having a substituent convertible into a quaternary ammonium group onto the irradiated polymer film; and a step of converting the substituent convertible into a quaternary ammonium group into a quaternary ammonium group. In this step, the substituent capable of forming a salt with a fluoride ion is a quaternary ammonium group, and a quaternary ammonium group has an advantage of high selective affinity for carbon dioxide. Since the substituent capable of forming a salt with a fluoride ion is a group that has not formed a salt with a fluoride ion, the counter ion to the quaternary ammonium group is also an anion other than a fluoride ion.

Preferably, the substituent convertible into a quaternary ammonium group is at least one selected from the group consisting of a pyridyl group, an imidazolyl group, a primary amino group, a secondary amino group, a tertiary amino group, and a halogenated alkyl group. Examples of the monomer having any of these substituents include vinylpyridine, vinylimidazole, chloromethylstyrene, bromomethylstyrene, acrylamide, dimethylaminopropyl acrylamide, and 1,2,2,6,6-pentamethyl-4-piperidyl methacrylate.

The graft polymerization can be carried out in a solid-liquid two-phase system containing a monomer solution obtained by dissolving a monomer having a substituent convertible into a quaternary ammonium group in a solvent and a irradiated polymer film placed in the monomer solution. It is also preferable to carry out the graft polymerization in an atmosphere with an oxygen concentration as low as possible in order to prevent the reaction from being inhibited by the presence of oxygen, as in the above-described step.

As the solvent used for the monomer solution, a solvent that dissolves the monomer but does not dissolve the polymer film is selected. Specific examples of the solvent include aromatic hydrocarbons such as benzene, toluene, and xylene, and aromatic compounds such as phenols (for example, phenol and cresol), but the solvent is not limited to these. When the aromatic compound is used as a solvent, a high graft ratio can be achieved. In addition, since the aromatic compound dissolves a homopolymer as a by-product, the polymerization reaction mixture can be kept homogeneous. The solubility of the monomer and the polymer film in the solvent may vary depending on the structures, polarities, etc. of the monomer and the polymer film. Therefore, the solvent may be selected as appropriate according to the types of the monomer and the polymer film. The solvent may be a mixed solvent of two or more types of solvents. However, amide compounds such as dimethylacetamide, N-methylpyrrolidone, and dimethylformamide; sulfoxides such as dimethyl sulfoxide; phosphoric amides such as hexamethylphosphoric triamide; sulfonamides, etc. are usually unsuitable for use as solvents because they tend to dissolve both the monomer and the polymer film. However, they can be selected depending on the types of the selected monomer and polymer film.

Another monomer may be added, if necessary, in addition to the monomer having a substituent convertible into a quaternary ammonium group. As a crosslinking agent, a compound having a plurality of unsaturated bonds in the molecule may be added to the solution. If the monomer and the crosslinking agent coexist in the graft polymerization, a crosslinked structure is formed between grafted chains. Therefore, the durability of the finally obtained carbon dioxide separation membrane can be further improved.

The concentration of the monomer in the monomer solution (the total concentration of the monomer and the crosslinking agent if the crosslinking agent is added) is preferably 0.2 to 3 mol/L, and more preferably 0.5 to 2.5 mol/L. When the concentration of the monomer is less than 0.2 mol/L, the graft reaction may not proceed sufficiently. When the concentration of the monomer is more than 3 mol/L, the reaction may occur outside the film or the yield may decrease, because homopolymers, which do not contribute to a graft reaction, are increasingly produced by polymerization of only monomers, and chain transfer by the monomers tends to occur and a termination reaction dominates, resulting in a decrease in the graft ratio.

A polymerization inhibitor may further be added to the monomer solution, if necessary.

In order to remove dissolved oxygen, which inhibits the graft reaction, from the monomer solution, it is preferable to pour the monomer solution into a vessel of glass, stainless steel, or the like, and subject the monomer solution to vacuum degassing or bubbling with an inert gas such as nitrogen.

Then, the irradiated polymer film is put into the monomer solution with stirring to allow graft polymerization to proceed.

The reaction time of the graft polymerization is preferably about 10 minutes to 12 hours. The reaction temperature is preferably 0° C. to 100° C., and more preferably 40° C. to 80° C.

After the graft reaction, the polymer film is recovered by filtration or the like from the reaction solution. Then, the grafted polymer film is washed 3 to 6 times with an appropriate amount of solvent to remove the solvent, unreacted monomers, and homopolymers, followed by drying. As the washing solvent, a solvent, such as toluene, methanol, isopropyl alcohol, and acetone, that readily dissolves the monomers and the homopolymers but does not dissolve the polymer film and the grafted polymer film can be used.

In the graft polymerization, the graft ratio is preferably 15 to 130% by weight.

The recovered polymer film has introduced therein a grafted chain containing a repeating unit of a monomer having a substituent convertible into a quaternary ammonium group. Subsequently, the substituent convertible into a quaternary ammonium group is converted into a quaternary ammonium group.

Conversion into a quaternary ammonium group can be performed using a known quaternization process. For example, in the case where the substituent convertible into a quaternary ammonium group is a nitrogen⁻containing group such as a pyridyl group, an imidazolyl group, a primary amino group, a secondary amino group, or a tertiary amino group, the substituent can be converted into a quaternary ammonium group by subjecting the substituent to treatment with a bromoalkane (for example, methyl bromide, ethyl bromide, etc.) or an iodoalkane (for example, methyl iodide, ethyl iodide, etc.). For example, in the case where the substituent convertible into a quaternary ammonium group is a halogenated alkyl group, the substituent can be converted into a quaternary ammonium group by reacting the substituent with a tertiary amine (for example, triethylamine, etc.).

Step (3)

The step (3) can be performed, for example, by immersing the polymer film obtained in the step (2), that is, the polymer film having a grafted side chain containing a repeating unit of a monomer having a substituent capable of forming a salt with a fluoride ion, in an aqueous solution of an inorganic fluoride salt.

Examples of the inorganic fluoride salt include potassium fluoride and cesium fluoride.

The concentration of the aqueous solution of the inorganic fluoride salt is, for example, 0.5 to 2.0 M, and preferably 1.0 to 1.5 M.

The immersion time is, for example, 6 to 48 hours, and preferably 12 to 24 hours.

After the immersion, the polymer film may be washed with pure water or the like, as appropriate.

The polymer film thus obtained has a grafted side chain containing a repeating unit of a monomer having a substituent forming a salt with a fluoride ion. Fluoride ions have a high ability to interact with carbon dioxide. Therefore, the polymer film serves as a carbon dioxide separation membrane in which carbon dioxide readily dissolves and which exhibits high selective permeability to carbon dioxide. In addition, since a substituent having high selective affinity for carbon dioxide is introduced into the polymer film by graft polymerization, the resulting polymer film serves as a highly durable carbon dioxide separation membrane. For example, even if condensation of water in the feed gas occurs, the polymer chain having a functional group with high affinity for carbon dioxide never elutes from the membrane and thus the membrane exhibits high water resistance. Therefore, even in the case where a wet gas is used, the membrane can exhibit high carbon dioxide separation capability for a long period of time.

Another aspect of the present invention is a carbon dioxide separation membrane including a polymer film having a grafted side chain containing a repeating unit of a monomer having a substituent forming a salt with a fluoride ion.

The substituent forming a salt with a fluoride ion is preferably a quaternary ammonium group forming a salt with a fluoride ion.

The polymer film is as described above, and it is preferably a film of at least one polymer selected from the group consisting of polystyrene, polyetheretherketone, polyetherketone, polysulfone, polyethersulfone, polyphenylene sulfide, polyarylate, polyetherimide, aromatic polyimide, polyamideimide, polyethylene, polypropylene, polyvinylidene fluoride, polyvinyl fluoride, ethylene-tetrafluoroethylene copolymer, vinylidene fluoride-hexafluoropropylene copolymer, crosslinked polytetrafluoroethylene, tetrafluoroethylene-perfluoroalkyl vinyl ether copolymer, and tetrafluoroethylene-hexafluoropropylene-vinylidene fluoride copolymer.

In the carbon dioxide separation membrane of the present invention, the graft ratio of the grafted side chain is preferably 20 to 200% by weight.

### EXAMPLES

Hereinafter, the present invention will be described in detail with reference to Examples and Comparative Examples, but the present invention is not limited to these examples.

### Example 1

As a polymer film, a film (crystallinity of 51%) with a thickness of 50 pm obtained by extruding polyvinylidene fluoride (PVdF: KUREHA KF polymer #1000, manufactured by Kureha Chemical Industry Co., Ltd.) was prepared. This PVdF film was cut into a 8-cm square, and irradiated with an electron beam at room temperature under the conditions of an accelerating voltage of 300 kV and a dose of 90 kGy. After the irradiation, the film was once cooled to dry ice temperature and stored until the next step was performed.

Next, 28 g of 4-vinylpyridine and 12 g of ethanol were mixed together to prepare a monomer solution. This monomer solution was put into a test tube, heated to 70° C., and bubbled with nitrogen to remove oxygen in the system. The PVdF film thus irradiated with an electron beam was immersed in this solution for 2 hours for graft polymerization. After the film was taken out of the solution, it was immersed and washed in toluene for no less than one hour. Subsequently, the film was washed with methanol for 10 minutes, and then dried in a dryer at 60° C. Thus, a 4-vinylpyridine-grafted membrane was obtained. The graft ratio of the grafted membrane thus obtained was 78%.

20 g of iodoethane and 80 g of methanol were mixed together to prepare a pyridine-ring quaternization solution. This quaternization solution was maintained at 50° C., and the obtained grafted membrane was immersed therein. The quaternization solution was stirred for one day under light shielding, and thus pyridine-ring quaternization was performed. After the quaternization, the grafted membrane was immersed and washed in methanol for 30 minutes. This washing with methanol was repeated twice. Subsequently, the grafted membrane was immersed in a mixed solution of 0.5 M NaNO₃ and 0.5 M Na₂SO₄ for 8 hours, and then immersed and washed in pure water for one day. After the washing, the grafted membrane was immersed in a 1 M aqueous solution of potassium fluoride for 8 hours and then washed with pure water for one day. Thus, a quaternized 4-vinylpyridine-grafted membrane having fluorine ions as counter ions was obtained as a carbon dioxide separation membrane.

### Example 2

The PVdF film (thickness of 50 μm) prepared in Example 1 was cut into a 8-cm square, and irradiated with an electron beam at room temperature under the conditions of an accelerating voltage of 300 kV and a dose of 90 kGy. After the irradiation, the film was once cooled to dry ice temperature and stored until the next step was performed.

Next, 28 g of chloromethylstyrene and 12 g of xylene were mixed together to prepare a monomer solution. This monomer solution was put into a test tube, heated to 70° C., and bubbled with nitrogen to remove oxygen in the system. The PVdF film thus irradiated with an electron beam was immersed in this solution for 10 hours for graft polymerization. After the film was taken out of the solution, it was immersed and washed in toluene for no less than 30 minutes and in acetone for no less than 30 minutes, respectively. The film was further washed with acetone for 10 minutes, and then dried in a dryer at 60° C. Thus, a 4-chloromethylstyrene-grafted membrane was obtained. The graft ratio of the grafted membrane thus obtained was 89%.

The above grafted membrane was immersed in a 30% trimethylamine ethanol solution (manufactured by Aldrich) so as to perform quaternization of chloromethyl groups. After the quaternization, the grafted membrane was immersed and washed in methanol for 30 minutes. This washing with methanol was repeated twice. Subsequently, the grafted membrane was immersed in a mixed solution of 0.5 M NaNO₃ and 0.5 M Na₂SO₄ for 8 hours, and then immersed and washed in pure water for one day. After the washing, the grafted membrane was immersed in a 1 M aqueous solution of potassium fluoride for 8 hours and then washed with pure water for one day. Thus, a quaternized aminomethylstyrene-grafted membrane having fluorine ions as counter ions was obtained as a carbon dioxide separation membrane.

### Comparative Example 1

The PVdF film (thickness of 50 μm) prepared in Example 1 was used as a carbon dioxide separation membrane without any treatment.

### Comparative Example 2

The PVdF film (thickness of 50 μm) prepared in Example 1 was cut into a 8-cm square, and irradiated with an electron beam at room temperature under the conditions of an accelerating voltage of 300 kV and a dose of 30 kGy. After the irradiation, the film was once cooled to dry ice temperature and stored until the next step was performed.

Next, 12 g of methacrylamide and 18 g of ethanol were mixed together to prepare a monomer solution. This monomer solution was put into a test tube, heated to 70° C., and bubbled with nitrogen to remove oxygen in the system. The PVdF film thus irradiated with an electron beam was immersed in this solution for 3 hours for graft polymerization. After the film was taken out of the solution, it was immersed and washed in ethanol for no less than one hour. Subsequently, the film was washed with methanol for 10 minutes, and then dried in a dryer at 60° C. Thus, a methacrylamide-grafted membrane was obtained as a carbon dioxide separation membrane. The graft ratio of the grafted membrane thus obtained was 35%.

For the carbon dioxide separation membranes obtained in Examples and Comparative Examples, the carbon dioxide separation capability was evaluated by the following method. Table 1 shows the results.

[Evaluation of Carbon Dioxide Separation Capability]

A gas permeability measurement device (GL Sciences Inc.) was used for the evaluation by the equal pressure method and the differential pressure method. CO₂/He mixed gas at atmospheric pressure or a total pressure of 0.7 MPa was supplied to the feed side, and Ar gas at atmospheric pressure was circulated on the permeate side. The supplied mixed gas and the permeate-side Ar gas were humidified to a predetermined humidity with a bubbler. A portion of the permeate-side gas was injected into a gas chromatograph at regular intervals to determine changes in the concentrations of CO₂ and He. The measurement was performed until 15 hours after the supply of the feed gas. The CO₂ and He permeability coefficients were calculated based on the increases in the CO₂ concentration and the He concentration over time. The setup conditions for the gas permeability measurement device, the conditions of gas chromatography analysis, and the gas permeability calculation method are as follows.

(Setup Conditions for Gas Permeability Measurement Device)
Amount of gas supplied: 100 cc/min
Composition of gas supplied: CO₂/He (Volume ratio)=80/20 (humidified)
Permeate-side circulating gas: Ar (humidified)
Amount of permeate-side circulating gas: 10 cc/min
Permeation area: 8.04 cm²
Measurement temperature: 40° C.
Bubbler temperature: 35.9° C.

(Conditions of Gas Chromatography Analysis)
Amount of Ar carrier gas: about 10 cc/min
TCD temperature: 150° C.
Oven temperature: 80° C.
TCD current: 70 mA
TCD polarity: [−] Low
TCD LOOP: 1 mL silicon steel tube of 1/16″×1.0×650 mm

(Performance Calculation Method)

The amount of gas permeated N was calculated from the gas concentration in the permeate-side circulating gas obtained by gas chromatography, and the gas permeability Q was calculated from the following equations 1 and 2. The separation factor a was calculated from the equation 3.

$$\begin{matrix}[ Equation 1 ] & \\ {Q}_{CO 2} = \frac{{N}_{CO 2}}{A \times ( {P}_{f} \times {X}_{CO 2} - {P}_{p} \times {Y}_{CO 2} )} & 1 \\ {Q}_{He} = \frac{{N}_{He}}{A \times ( {P}_{f} \times {X}_{He} - {P}_{p} \times {Y}_{He} )} & 2 \\ α = \frac{( {Y}_{CO 2} / {Y}_{He} )}{( {X}_{CO 2} / {X}_{He} )} & 3\end{matrix}$$

where N_{CO2} and N_{He} are the amount of permeated CO₂ and the amount of permeated He, respectively, P_{f} and Pₚ are the total pressure of the feed gas and the total pressure of the permeate gas, respectively, A is the area of the membrane, X_{CO2} and X_{He} are the molar fraction of CO₂ and the molar fraction of He, respectively, in the feed gas, and Y_{CO2} and Y_{He} are the molar fraction of CO₂ and the molar fraction of He, respectively, in the permeate gas.

TABLE 1

| | | | | Differential pressure method | | |
|---|---|---|---|---|---|---|
| | | | | (Transmembrane pressure difference | | |
| | Equal pressure method | | | of 0.6 Mpa) | | |
| | | Q_{CO2} | Q_{He} | | Q_{CO2} | Q_{He} |
| | α | (m³/m²/Pa/s) | (m³/m²/Pa/s) | α | (m³/m²/Pa/s) | (m³/m²/Pa/s) |
| Example 1 | 41.37 | 2.05 × 10⁻¹¹ | 4.90 × 10⁻¹³ | 19.30 | 6.02 × 10⁻¹² | 3.16 × 10⁻¹³ |
| Example 2 | 20.2 | 3.51 × 10⁻¹¹ | 1.72 × 10⁻¹² | 16.2 | 1.37 × 10⁻¹¹ | 8.43 × 10⁻¹³ |
| Com. | 0.27 | 8.11 × 10⁻¹⁴ | 2.98 × 10⁻¹³ | 0.38 | 1.47 × 10⁻¹³ | 3.84 × 10⁻¹³ |
| Example 1 | | | | | | |
| Com. | 5.19 | 1.05 × 10⁻¹² | 2.01 × 10⁻¹³ | 0.71 | 1.26 × 10⁻¹³ | 1.77 × 10⁻¹³ |
| Example 2 | | | | | | |

Table 1 shows that the carbon dioxide separation membranes of Examples 1 and 2, which are the carbon dioxide separation membranes of the present invention, exhibited particularly high carbon dioxide separation capability.

### INDUSTRIAL APPLICABILITY

The carbon dioxide separation membrane of the present invention is used to separate carbon dioxide from other gases, and for example, can be used for various applications such as separation of carbon dioxide from combustion exhaust gases, separation of carbon dioxide from natural gases, separation of carbon dioxide in integrated coal gasification combined cycle power generation, and separation of carbon dioxide in membrane reactors for hydrogen production for fuel cells.

1. A method for producing a carbon dioxide separation membrane, the method comprising the steps of:
(1) irradiating a polymer film with radiation;
(2) forming, in the irradiated polymer film, a grafted chain containing a repeating unit of a monomer having a substituent capable of forming a salt with a fluoride ion; and
(3) subjecting the substituent capable of forming a salt with a fluoride ion to treatment with a fluoride salt so as to form a salt with a fluoride ion in the substituent.

2. The method for producing a carbon dioxide separation membrane according to claim 1, wherein
in the step (2), the substituent capable of forming a salt with a fluoride ion is a quaternary ammonium group, and
the step (2) comprises the steps of: graft-polymerizing a monomer having a substituent convertible into a quaternary ammonium group onto the irradiated polymer film; and converting the substituent convertible into a quaternary ammonium group into a quaternary ammonium group.

3. The method for producing a carbon dioxide separation membrane according to claim 2, wherein the substituent convertible into a quaternary ammonium group is at least one selected from the group consisting of a pyridyl group, an imidazolyl group, a primary amino group, a secondary amino group, a tertiary amino group, and a halogenated alkyl group.

4. The method for producing a carbon dioxide separation membrane according to claim 2, wherein in the step of graft-polymerizing the monomer having the substituent convertible into a quaternary ammonium group in the step (2), a graft ratio is 15 to 130% by weight.

5. The method for producing a carbon dioxide separation membrane according to claim 1, wherein the polymer film is a film of at least one polymer selected from the group consisting of polystyrene, polyetheretherketone, polyetherketone, polysulfone, polyethersulfone, polyphenylene sulfide, polyarylate, polyetherimide, aromatic polyimide, polyamideimide, polyethylene, polypropylene, polyvinylidene fluoride, polyvinyl fluoride, ethylene-tetrafluoroethylene copolymer, vinylidene fluoride-hexafluoropropylene copolymer, crosslinked polytetrafluoroethylene, tetrafluoroethylene-perfluoroalkyl vinyl ether copolymer, and tetrafluoroethylene-hexafluoropropylene-vinylidene fluoride copolymer.

6. A carbon dioxide separation membrane comprising a polymer film having a grafted side chain containing a repeating unit of a monomer having a substituent forming a salt with a fluoride ion.

7. The carbon dioxide separation membrane according to claim 6, wherein the substituent forming a salt with a fluoride ion is a quaternary ammonium group forming a salt with a fluoride ion.

8. The carbon dioxide separation membrane according to claim 6, wherein the polymer film is a film of at least one polymer selected from the group consisting of polystyrene, polyetheretherketone, polyetherketone, polysulfone, polyethersulfone, polyphenylene sulfide, polyarylate, polyetherimide, aromatic polyimide, polyamideimide, polyethylene, polypropylene, polyvinylidene fluoride, polyvinyl fluoride, ethylene-tetrafluoroethylene copolymer, vinylidene fluoride-hexafluoropropylene copolymer, crosslinked polytetrafluoroethylene, tetrafluoroethylene-perfluoroalkyl vinyl ether copolymer, and tetrafluoroethylene-hexafluoropropylene-vinylidene fluoride copolymer.

9. The carbon dioxide separation membrane according to claim 6, wherein a graft ratio of the grafted side chain is 20 to 200% by weight.
